(19) United States
(12) Patent Application Publication
(10) Pub. No.: US 2018/0268397 A1
(43) Pub. Date: Sep. 20, 2018

(54) MOBILE STAMP DEVICE

(71) Applicant: BD, Inc., Seoul (KR)

(72) Inventors: In Seong HWANG, Seoul (KR); Kee Young KIM, Seoul (KR)

(21) Appl. No.: 15/550,356

(22) PCT Filed: Dec. 11, 2015
(86) PCT No.: PCT/KR2015/013595

§ 371 Date: Oct. 26, 2017

(30) Foreign Application Priority Data
Apr. 29, 2015 (KR) 1020150060867

(51) Int. Cl. G06Q 20/32; G06Q 20/38

(52) U.S. Cl. CPC G06Q 20/3278; G06Q 20/385

(57) ABSTRACT

The present invention relates to a mobile stamp device and an electronic stamp payment system using the same, and the mobile stamp device linked with a user terminal so as to perform a payment for a product or a service comprises: an input unit for receiving a list or a price (or information for checking the price) for the product or service for which the purchase thereof has been requested; a display unit for displaying the list or the price (or information for checking the price) inputted through the input unit, or displaying a payment process result; and a control unit for controlling operation of the corresponding mobile stamp device. Therefore, an offline purchase can be conveniently requested by linking with a smart phone.

### CROSS-REFERENCE TO RELATED APPLICATIONS

This application is the National Stage Entry of International Patent Application No. PCT/KR2015/013595, filed on Dec. 11, 2015, and claims priority from and the benefit of Korean Patent Application No. 10-2015-0060867, filed on Apr. 29, 2015, each of which is incorporated by reference for all purposes as if fully set forth herein.

### BACKGROUND

### Field

The present invention relates to an electronic stamp payment technique, and more specifically, to a mobile stamp device which can conveniently request a purchase in association with a smart phone in an offline space.

### Discussion of the Background

Generally, a recent trend is adopting a touch panel capable of recognizing multiple touches to optimize image output and user input using a display of a small size in a portable terminal of a touch screen method, and here, a multi-touch technique is a technique of recognizing several touch points simultaneously, which allows further diverse handling compared with a technique of generally recognizing only one touch point. In a mobile onsite payment, if a POS terminal reads and transmits payment information of the portable terminal of a touch screen method to a server through a Near Field Communication (NFC) reader or the like, the server approves and processes the onsite payment.

### SUMMARY

Therefore, the present invention has been made in view of the above problems, and it is an object of the present invention to provide a mobile stamp device which can conveniently request a purchase in an offline space in association with a smart phone.

Another object of the present invention is to provide a mobile stamp device which can input a purchase description or an amount of money (or information for confirming the amount) and display an input result or a payment process result.

Another object of the present invention is to provide an electronic stamp payment system which can make an onsite payment using a mobile stamp device and a smart phone although at least one of an NFC dongle and a POS terminal is not provided.

Another object of the present invention is to provide an electronic stamp payment system for confirming a person who pays for electronic documents.

Exemplary embodiments provide a mobile stamp device for making a payment for a product or a service in association with a user terminal, the device including: an input unit for receiving a list or amounts (or information for confirming the amounts) of products or services requested to purchase; a display unit for displaying the list or the amounts (or information confirming the amounts) inputted through the input unit or displaying a payment process result; and a control unit for controlling operation of a corresponding mobile stamp device.

In an embodiment, the input unit may include at least one of a key pad, a direction button assembly, a wheel button and a touch pad.

In an embodiment, the mobile stamp device may further include a stamp pattern structure that can be recognized by a touch screen of the user terminal.

In an embodiment, when the stamp pattern structure is touched to the touch screen, the user terminal may receive a corresponding pattern and display a product or service provider corresponding to the pattern on a screen.

In an embodiment, the stamp pattern structure may be formed in a unique pattern for identifying a corresponding mobile stamp device.

In an embodiment, the mobile stamp device may further include a first wireless communication unit capable of transmitting and receiving data to and from the user terminal.

In an embodiment, the first wireless communication unit may include at least one of an optical communication module, a Bluetooth (BLE) communication module, a near field communication (NFC) module, and an ultrasonic or audible ultrasonic communication module.

In an embodiment, the control unit may put a stamp on the user terminal by transmitting a stamping signal to the user terminal through the first wireless communication unit.

For example, when the mobile stamp device physically contacts with the user terminal or receives a command through a button provided in the mobile stamp device, the control unit may put a stamp on the user terminal in a method of transmitting identification information of the mobile stamp device to the user terminal through the first wireless communication unit.

Stamping means transmitting information by physically contacting with the touch screen of the user terminal (a method of transferring information by touching the stamp pattern structure to the touch screen) or transmitting information through a wireless communication means (sound waves, light, Bluetooth (BLE), near field communication (NFC) or the like) (a method of transferring information when a command is received through a button).

In an embodiment, the control unit may transmit payment information on the products or services to the stamped user terminal through the first wireless communication unit.

In an embodiment, the payment information may include at least one or more of unique identification information of a corresponding mobile stamp device, a One Time Password (OTP) and a list or amounts (or information for confirming the amounts) of products or services requested to purchase.

In an embodiment, the control unit may receive the payment information on the products or services from the stamped user terminal through the first wireless communication unit.

In an embodiment, the payment information may include at least one or more of a One Time Password (OTP) and information on a payment means.

In an embodiment, the mobile stamp device may further include a second wireless communication unit capable of transmitting and receiving data to and from an electronic stamp payment server.

In an embodiment, the second wireless communication unit may include at least one of a Bluetooth communication module, a wireless LAN module and a cellular communication module.

In an embodiment, the control unit may receive a payment process result from the electronic stamp payment server through the second wireless communication unit.

In an embodiment, the control unit may transmit the payment information received from the user terminal to the electronic stamp payment server through the second wireless communication unit.

In an embodiment, the mobile stamp device may further include a fingerprint input unit for authenticating a user of a corresponding mobile stamp device.

According to another exemplary embodiment, there is provided a mobile stamp device for making a payment for a product or a service in association with a user terminal, the device including: an input unit for receiving identification information of a location providing the product or service (e.g., a table number or the like in a store); and a control unit for controlling operation of a corresponding mobile stamp device.

In an embodiment, the mobile stamp device may further include a display unit for displaying the identification information inputted through the input unit or displaying a payment process result.

In an embodiment, the input unit may include at least one of a joggle shuttle, a key pad, a direction button assembly, a wheel button and a touch pad.

In an embodiment, the control unit may transmit the inputted identification information to an electronic stamp payment server and receive a product or service providing list or amounts thereof (or information for confirming the amounts) corresponding to the identification information from the electronic stamp payment server.

In an embodiment, the control unit may transmit the inputted identification information to an order management device and receive a product or service providing list or amounts thereof corresponding to the identification information from the order management device.

In an embodiment, the control unit may put a stamp on the user terminal by transmitting a stamping signal to the user terminal.

For example, when the mobile stamp device physically contacts with the user terminal or receives a command through a button provided in the mobile stamp device, the control unit may put a stamp on the user terminal in a method of transmitting identification information of the mobile stamp device to the user terminal through the first wireless communication unit.

In an embodiment, the control unit may transmit unique identification information of a corresponding mobile stamp device and a product or service providing list or amounts thereof (or information for confirming the amounts) corresponding to the inputted identification information to the stamped user terminal.

In an embodiment, the mobile stamp device may further include a fingerprint input unit for authenticating a user of a corresponding mobile stamp device.

According to another exemplary embodiment, there is provided an electronic stamp payment system for making a payment for a product or a service, the system including: a mobile stamp device for receiving a list or amounts (or information for confirming the amounts) of products or services requested to purchase; a user terminal for transmitting payment information in association with the mobile stamp device, if a stamping event is generated as the touch screen is physically touched by the mobile stamp device or a stamping signal is received from the mobile stamp device; and an electronic stamp payment server for receiving the payment information and the list or the amounts (or information for confirming the amounts) of the products or services requested to purchase and making a payment for the product or service.

In an embodiment, if the stamping event is generated, the mobile stamp device may transmit the payment information on the product or service to the user terminal, and the user terminal may transmit the received payment information to the electronic stamp payment server.

In an embodiment, the payment information may include at least one or more of unique identification information of a corresponding mobile stamp device, a One Time Password (OTP) and a list or amounts (or information for confirming the amounts) of products or services requested to purchase.

In an embodiment, if the stamping event is generated, the user terminal may transmit the payment information to the mobile stamp device, and the mobile stamp device may transmit the received payment information, the unique identification information of a corresponding mobile stamp device, and the list or the amounts (or information for confirming the amounts) of the products or services requested to purchase to the electronic stamp payment server.

In an embodiment, the payment information may include at least one or more of a One Time Password (OTP) and information on a payment means.

In an embodiment, if the payment is approved, the electronic stamp payment server may accumulate points related to the corresponding payment details and update the points for the user of the user terminal.

In an embodiment, if the payment is approved, the electronic stamp payment server may transmit a coupon related to the corresponding payment details to the user terminal.

In an embodiment, the electronic stamp payment server may make a payment for the corresponding products or services using the points previously accumulated for the user or the coupon previously issued to the user terminal.

According to another exemplary embodiment, there is provided an electronic stamp payment system for making a payment for a product or a service, the system including: an order management device for receiving a product or service providing list or amounts thereof (or information for confirming the amounts) of each location providing the product or service and transmitting the list or the amounts to the electronic stamp payment server; a mobile stamp device for receiving identification information of the location providing the product or service (e.g., a table number of a store) under the user's control and receiving a product or service providing list or amounts thereof (or information for confirming the amounts) corresponding to the location from the electronic stamp payment server on the basis of the inputted identification information; a user terminal for receiving, if a stamping event is generated as the touch screen is physically touched by the mobile stamp device or a stamping signal is received from the mobile stamp device, the product or service providing list or the amounts (or information for confirming the amounts) from the mobile stamp device and transmitting payment information; and an electronic stamp payment server for receiving the payment information and making a payment for the corresponding product or service.

In an embodiment, if the stamping event is generated, the mobile stamp device may transmit the payment information on the product or service to the user terminal, and the user terminal may transmit the received payment information to the electronic stamp payment server.

In an embodiment, the payment information may include at least one or more of unique identification information of a corresponding mobile stamp device and a One Time Password (OTP).

In an embodiment, the user terminal may transmit the payment information and the list providing the products or services requested to purchase or the amounts (or information for confirming the amounts) to the electronic stamp payment server.

In an embodiment, the user terminal may transmit the payment information and the identification information of the location providing the product or service to the electronic stamp payment server.

In an embodiment, if the payment is approved, the electronic stamp payment server may accumulate points related to the corresponding payment details and update the points for the user of the user terminal.

In an embodiment, if the payment is approved, the electronic stamp payment server may transmit a coupon related to the corresponding payment details to the user terminal.

In an embodiment, the electronic stamp payment server may make a payment for the corresponding products or services using the points previously accumulated for the user or the coupon previously issued to the user terminal.

According to another exemplary embodiment, there is provided a method of making a payment for a product or a service, the method including the steps of: receiving a list or amounts (or information for confirming the amounts) of products or services requested to purchase, by a mobile stamp device; transmitting payment information in association with the mobile stamp device, if a stamping event is generated as the touch screen is physically touched by the mobile stamp device or a stamping signal is received from the mobile stamp device, by a user terminal; and making a payment for the products or services, if the payment information and a list or amounts (or information for confirming the amounts) of the products or services requested to purchase is received, by an electronic stamp payment server.

According to another exemplary embodiment, there is provided a method of making a payment for a product or a service, the method including the steps of: receiving a product or service providing list or amounts of a location providing a specific product or service, by an order management device; transmitting the product or service providing list or the amounts of the location providing the specific product or service to the electronic stamp payment server, by the order management device; receiving identification information of the location providing the product or service (e.g., a table number or the like in a store) under the user's control, by a mobile stamp device; receiving a product or service providing list or amounts thereof corresponding to the location from the electronic stamp payment server on the basis of the inputted identification information, by the mobile stamp device; receiving, if a stamping event is generated as the touch screen is physically touched by the mobile stamp device or a stamping signal is received from the mobile stamp device, the product or service providing list or the amounts from the mobile stamp device, by a user terminal; transmitting payment information under the user's control, by the user terminal; and making a payment for the corresponding product or service if the payment information is received, by an electronic stamp payment server.

The mobile stamp device according to an embodiment of the present invention can conveniently request a purchase in an offline space in association with a smart phone.

The mobile stamp device according to an embodiment of the present invention can input a purchase description or an amount of money (or information for confirming the amount) and display an input result or a payment process result.

The mobile stamp device according to an embodiment of the present invention can make an onsite payment using a mobile stamp device and a smart phone although an NFC dongle or a POS terminal is not provided.

### BRIEF DESCRIPTION OF THE DRAWINGS

FIG. 1 is a view showing an electronic stamp payment system using a mobile stamp device according to an embodiment of the present invention.

FIG. 2 is a view showing an embodiment of the mobile stamp device shown in FIG. 1.

FIG. 3 is a view showing another embodiment of the mobile stamp device shown in FIG. 1.

FIG. 4 is a block diagram showing the mobile stamp device shown in FIG. 1.

FIG. 5 is a view showing a screen of stamping on a user terminal using the mobile stamp device shown in FIG. 1.

FIG. 6 is a view showing a screen of selecting a payment means at the user terminal shown in FIG. 1.

FIG. 7 is a view showing a screen of inputting a password at the user terminal shown in FIG. 1.

FIG. 8 is a view showing a screen of outputting payment details provided by the electronic stamp payment server shown in FIG. 1 to a user terminal.

FIG. 9 is a view showing a screen of outputting a payment receipt provided by the electronic stamp payment server shown in FIG. 1 to a user terminal.

FIG. 10 is a view showing a screen of an electronic stamp accumulation result provided by the user terminal shown in FIG. 1.

FIG. 11 is a view showing a screen of a point accumulation result provided by the user terminal shown in FIG. 1.

FIG. 12 is a view showing an electronic stamp payment system using a mobile stamp device according to another embodiment of the present invention.

FIG. 13 is a view showing a screen of a product or service providing list or amounts thereof provided by the user terminal shown in FIG. 12.

FIG. 14 is a flowchart illustrating a payment process performed by the electronic stamp payment system shown in FIG. 1.

FIG. 15 is a flowchart illustrating a payment process performed by the electronic stamp payment system shown in FIG. 12.

### DETAILED DESCRIPTION OF THE ILLUSTRATED EMBODIMENTS

Since the descriptions of the present invention are merely embodiments for structural and functional descriptions, the scope of the present invention should not be interpreted as being restricted by the embodiments described in the detailed descriptions of the present invention. That is, since the embodiments may be diversely changed and may have various forms, the scope of the present invention should be understood to include equivalents which can realize the technical spirits. In addition, since the purposes or effects presented in the present invention do not mean that a specific embodiment should include all of these or include only such effects, it should not be understood that the scope of the present invention is restricted thereby.

Meanwhile, the meaning of the terms described in this application should be understood as follows.

The terms such as “first”, “second” and the like are to distinguish an element from the other elements, and the scope of the present invention should not be limited by these terms. For example, a first element may be named as a second element, and similarly, a second element may also be named as a first element.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

As used herein, the singular forms “a”, “an” and “the” are intended to include the plural forms as well, unless the context clearly indicates otherwise, and it will be further understood that the terms “comprises”, “comprising,”, “includes” and/or “including”, when used herein, specify the presence of stated features, integers, steps, operations, elements, components, and/or groups thereof, but do not preclude the presence or addition of one or more other features, integers, steps, operations, elements, components, and/or groups thereof.

In each of the steps, reference numerals (e.g., a, b, c and the like) are used for the convenience of explanation, and the reference numerals do not describe the order of the steps, and the steps may occur in a sequence different from a specified order unless the specific order is clearly disclosed in context. That is, the steps may occur in a sequence the same as the specified order, may be performed simultaneously in practice, or may be performed in a reverse order.

The present invention may be implemented as a code that can be read by a computer in a recording medium that can be read by a computer, and the recording medium that can be read by a computer includes all kinds of recording devices in which data that can be read by a computer system are stored. Examples of the recording medium that can be read by a computer are ROM, RAM, CD-ROM, a magnetic tape, a floppy disk, an optical data storage device and the like, and in addition, a medium implemented in the form of a carrier wave (e.g., transmission through the Internet) is also included. In addition, since the recording medium that can be read by a computer may be distributed in computer systems connected through a network, the code that can be read by a computer can be stored and executed in a distributed manner.

All the terms used herein has a meaning the same as is generally understood by those skilled in the art, unless defined otherwise. The terms defined in a generally used dictionary should be interpreted to coincide with meanings of the related art from the context. Unless obviously defined in the present invention, such terms are not interpreted as ideal or excessively formal meanings.

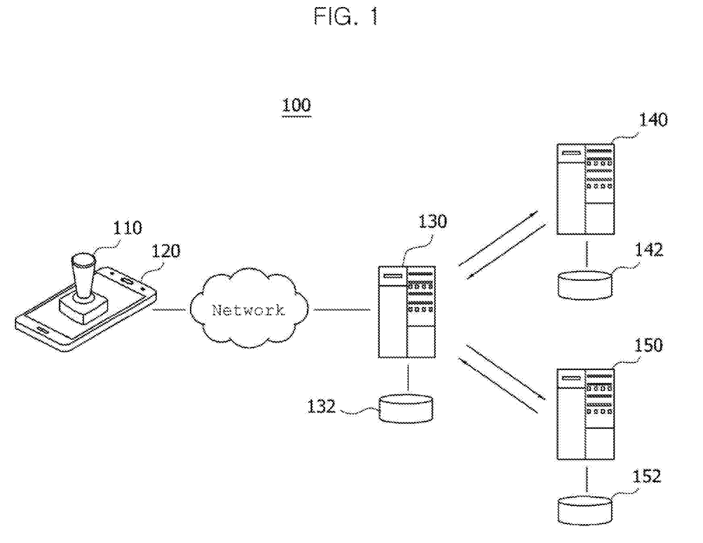

FIG. 1 is a view showing an electronic stamp payment system using a mobile stamp device according to an embodiment of the present invention.

Referring to FIG. 1, an electronic stamp payment system 100 includes a mobile stamp device 110, a user terminal 120, an electronic stamp payment server 130, a first database 132, a payment server 140, a second database 142, a stamp authentication server 150 and a third database 152.

The mobile stamp device 110 receives a list or amounts (or information for confirming the amounts (e.g., a table number in a store, a shopping cart number or the like)) of products or services requested to purchase and displays the received list or amounts (or the information for confirming the amounts). The mobile stamp device 110 may put an electronic stamp on the user terminal 120 under the user's control. In an embodiment, the mobile stamp device 110 may put an electronic stamp on the user terminal 120 by physically touching the touch screen of the user terminal 120 under the user's control. In another embodiment, the mobile stamp device 110 may put an electronic stamp on the user terminal 120 by transmitting a stamping signal under the user's control. For example, when the mobile stamp device 110 physically contacts with the user terminal 120 or receives a command from the user through a button provided in the mobile stamp device, it may put a stamp on the user terminal 120 in a method of transmitting identification information of the corresponding mobile stamp device 110 to the user terminal 120.

The user terminal 120 is connected to the electronic stamp payment server 130 through a network and may request a payment for the products or services requested to purchase by the user. If a stamping event is generated as the touch screen is physically touched by the mobile stamp device 110 or a stamping signal is received from the mobile stamp device 110, the user terminal 120 transmits payment information to the electronic stamp payment server 130 in association with the mobile stamp device 110. Here, the user terminal 120 may perform an electronic stamp payment process through an application related to electronic stamp payment.

In an embodiment, if a stamping event is generated, the mobile stamp device 110 may transmit first payment information of the products or services to the user terminal 120, and the user terminal 120 may transmit the received first payment information to the electronic stamp payment server 130.

In an embodiment, the first payment information may include at least one or more of unique identification information of a corresponding mobile stamp device, a One Time Password (OTP) and a list or amounts (or information for confirming the amounts) of the products or services requested to purchase. In an embodiment, the user terminal 120 may transmit at least one or more of user information and information on a payment means, together with the first payment information, to the electronic stamp payment server 130. The user information may include a user ID inputted when an application related to the payment is logged in or an identification code (i.e., a phone number) of the user terminal 120.

In another embodiment, if a stamping event is generated, the user terminal 120 may transmit second payment information to the mobile stamp device 110, and the mobile stamp device 110 may transmit the received second payment information, the unique identification information of a corresponding mobile stamp device, and the list or the amounts (or information for confirming the amounts) of the products or services requested to purchase to the electronic stamp payment server 130.

In an embodiment, the second payment information may include at least one or more of a One Time Password (OTP) and information on a payment means. In an embodiment, the second payment information may further include user information. The user information may include a user ID inputted when an application related to the payment is logged in or an identification code (i.e., a phone number) of the user terminal 120.

If whether or not the payment is approved is received from the electronic stamp payment server 130, the user terminal 120 may display a payment result. In an embodiment, the user terminal 120 may be implemented as a smart phone, a tablet PC, a desktop computer, a notebook computer or the like provided with an input and output device.

The electronic stamp payment server 130 is connected to the mobile stamp device 110 or the user terminal 120 through a network and may receive a payment request for purchase of the requested products or services from the mobile stamp device 110 or the user terminal 120. The electronic stamp payment server 130 may determine whether or not to approve the payment by performing user authentication for the payment request. The first database 132 stores information on affiliated stores joining the electronic stamp payment service and information on service subscribers.

The electronic stamp payment server 130 provides the mobile stamp device 110 or the user terminal 120 with whether or not the payment is approved. In an embodiment, if whether or not the payment is approved is received from the electronic stamp payment server 130, the mobile stamp device 110 or the user terminal 120 may display a payment process result.

In an embodiment, if the payment is approved, the electronic stamp payment server 130 may detect information on an affiliated store related to the identification information of the electronic stamp received from the user terminal 120 and provide information on the detected affiliated store to the user terminal 120.

In an embodiment, if the payment is approved, the electronic stamp payment server 130 may transmit a coupon related to the corresponding payment details to the user terminal 120. In another embodiment, if the payment is approved, the electronic stamp payment server 130 may accumulate points related to the corresponding payment details and update the points for the user of the user terminal. The electronic stamp payment server 130 may make a payment for the products or services requested to purchase using the points previously accumulated for the user or the coupon previously issued to the user terminal 120.

The electronic stamp payment server 130 is connected to the payment server 140 through a network and may transmit payment details including the payment means and the payment amount received from the mobile stamp device 110 or the user terminal 120 to the payment server 140. The electronic stamp payment server 130 may receive whether or not the payment requested by the user terminal 120 is approved and information on the difference of amount from the payment server 140 on the basis of the payment details.

The payment server 140 is connected to the electronic stamp payment server 130 through a network and may receive the payment details including the payment means and the payment amount from the electronic stamp payment server 130. The payment server 140 may determine whether or not to approve the payment by verifying validity of the payment details. In an embodiment, the payment server 140 may be managed by a credit card company, a bank, a communication company or an online payment service provider related to the payment means. The second database 142 stores information on the user.

In an embodiment, the electronic stamp payment server 130 may receive information on the electronic stamp from the user terminal 120 and transmit the received information on the electronic stamp to the stamp authentication server 150.

The stamp authentication server 150 authenticates the corresponding electronic stamp on the basis of the received information on the electronic stamp and transmits an authentication result to the electronic stamp payment server 130. The electronic stamp payment server 130 may determine whether or not to approve the requested payment on the basis of the authentication result received from the stamp authentication server 150.

The third database 152 stores affiliated stores joining the electronic stamp payment service and stamp patterns of the mobile stamp devices used by a corresponding affiliated store or unique identification information of the mobile stamp devices.

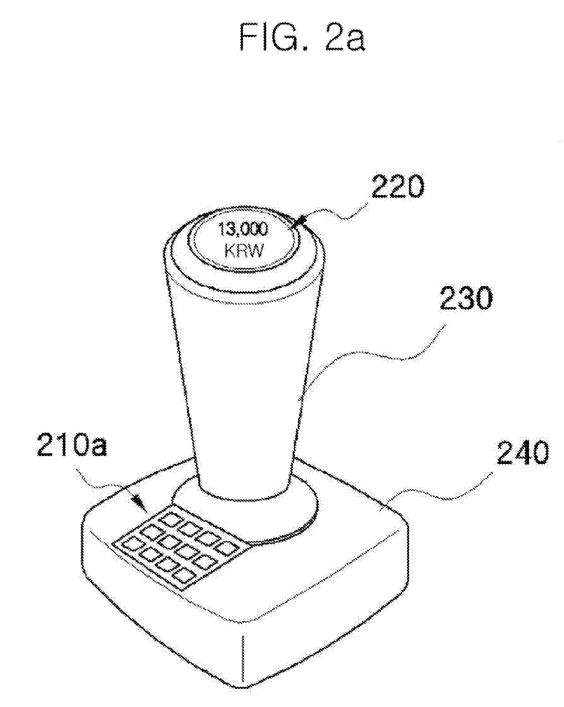

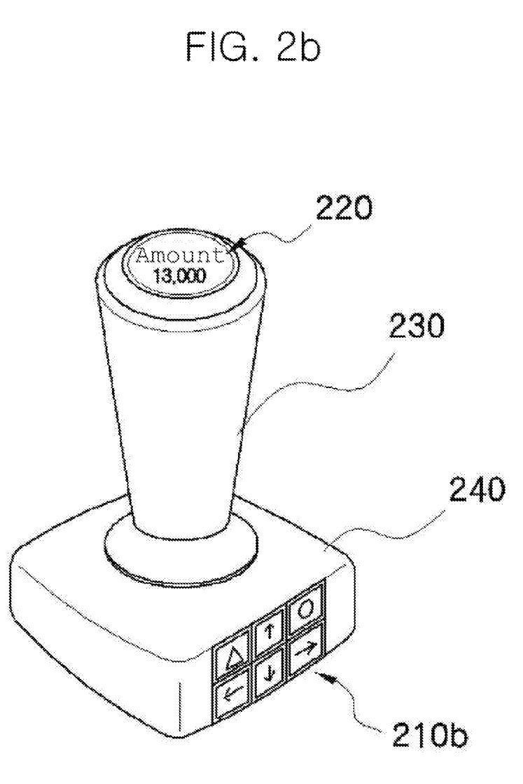

FIG. 2 is a view showing an embodiment of the mobile stamp device shown in FIG. 1.

Referring to FIG. 2, the mobile stamp device 110 includes an input unit 210a or 210b and a display unit 220. The input unit 210a or 210b receives a list or amounts (or information for confirming the amounts) of products or services requested to purchase under the user's control. In an embodiment, the input unit 210a or 210b may correspond to a key pad 210a or a direction button assembly 210b. In another embodiment, the input unit 210a or 210b may correspond to a wheel button or a touch pad.

For example, when a character and/or numeric key pad is provided in the mobile stamp device 110, the mobile stamp device 110 may receive a character or a number under the user's control and receive a list or amounts (or information for confirming the amounts) of the products or services requested to purchase on the basis of products or services corresponding to the received character or number. In another embodiment, the mobile stamp device 110 may directly receive a list or amounts (or information for confirming the amounts) of products or services requested to purchase through the character and/or numeric key pad.

When direction and selection buttons are provided in the mobile stamp device 110, the mobile stamp device 110 may receive a list or amounts (or information for confirming the amounts) of the products or services requested to purchase by selecting the products or services through the direction and selection buttons. For example, the mobile stamp device 110 may receive a command for selecting a menu of a list, an amount (or information for confirming the amount), a unit and the like through left and right buttons and receive a list or amounts (or information for confirming the amounts) of the products or services requested to purchase by selecting a number or a character through up and down buttons.

For example, if the ‘amount’ is selected from the menu through the left and right buttons and the confirmation button is pressed, the mobile stamp device 110 enters an amount input mode and may receive a unit of amount (a unit of 1, 10, 100, 100, 1,000 or the like) through the left and right buttons. If the unit of amount is selected, the mobile stamp device 110 may select a number corresponding to the unit through the up and down buttons and receive the selected number if the confirmation button is pressed.

The display unit 220 displays the list or the amounts (or information for confirming the amounts) of the products or services requested to purchase inputted by the input unit 210a or 210b. Or, the display unit 220 may display a list or amounts of a payment cancellation.

In an embodiment, when a payment process result is received from the electronic stamp payment server 130, the display unit 220 may display the received payment process result.

The input unit 210a or 210b and the display unit 220 may be placed on the handle 230 or the body 240 of the mobile stamp device. For example, the input unit 210a or 210b may be placed on the top surface or the side surface of the body 240. In another embodiment, the input unit 210a or 210b may be placed on the side surface of the handle 230.

In an embodiment, the display unit 220 may be placed on the top surface of an end of the handle 230 or on the top surface of the body 240. In an embodiment, the display unit 220 may include a fingerprint input unit and receive a fingerprint of a mobile stamp device user. The mobile stamp device 110 may directly authenticate a corresponding mobile stamp device user on the basis of the inputted fingerprint or may request authentication of the corresponding user by transmitting the inputted fingerprint to the electronic stamp payment server 130.

In an embodiment, the mobile stamp device 110 may put an electronic stamp on the user terminal 120 by physically touching the touch screen of the user terminal 120 under the user's control. In this case, the mobile stamp device 110 may be provided with a stamp pattern structure, which can be recognized by the touch screen of the user terminal 120, on the bottom surface of the body 240. The stamp pattern structure is formed in a unique pattern for identifying a corresponding mobile stamp device. That is, each mobile stamp device may be provided with a pattern structure of a different pattern.

When the stamp pattern structure of the mobile stamp device 110 is touched to the touch screen, the user terminal 120 receives and recognizes a corresponding pattern and displays a product or service provider corresponding to the pattern on the screen. That is, the user terminal 120 may output that a corresponding user terminal is stamped by the mobile stamp device 110 by displaying the product or service provider on the screen.

In another embodiment, the mobile stamp device 110 may put an electronic stamp on the user terminal 120 by transmitting a stamping signal under the user's control. When the stamping signal is received, the user terminal 120 receives unique identification information of the mobile stamp device that has transmitted the stamping signal and displays a product or service provider corresponding to the unique identification information of the screen. That is, the user terminal 120 may output that a corresponding user terminal is stamped by the mobile stamp device 110 by displaying the product or service provider on the screen.

In another embodiment, when the distance to the user terminal 120 is shortened within a predetermined distance, the mobile stamp device 110 may put an electronic stamp on the user terminal 120 by transmitting a stamping signal.

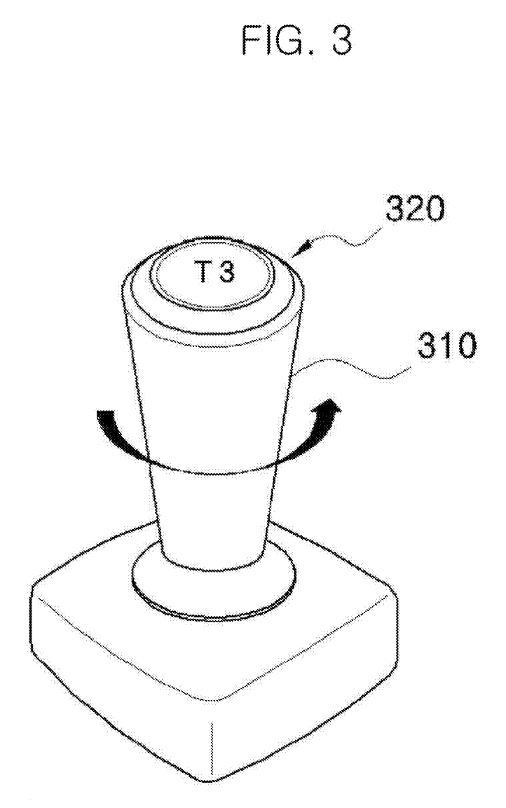

FIG. 3 is a view showing another embodiment of the mobile stamp device shown in FIG. 1.

Referring to FIG. 3, the mobile stamp device 110 includes an input unit 310 and a display unit 320. The input unit 110 may correspond to a rotating input means such as a jog shuttle. The input unit 310 may rotate under the user's control and select and receive a list or amounts (or information for confirming the amounts) of products or services requested to purchase through a rotating operation. In an embodiment, the input unit 310 may further include a confirmation button for confirming the selection.

The display unit 320 displays the list or the amounts (or information for confirming the amounts) of the products or services requested to purchase inputted by the input unit 310. Or, the display unit 320 may display a list or amounts (or information for confirming the amounts) of a payment cancellation.

The display unit 320 may be placed on the top surface of an end of the handle or on the top surface of the body. In an embodiment, the display unit 320 may include a fingerprint input unit and receive a fingerprint of a mobile stamp device user. The mobile stamp device 110 may directly authenticate a corresponding mobile stamp device user on the basis of the inputted fingerprint or request authentication of the corresponding user by transmitting the inputted fingerprint to the electronic stamp payment server 130.

In an embodiment, the mobile stamp device 110 may put an electronic stamp on the user terminal 120 by physically touching the touch screen of the user terminal 120 under the user's control. In another embodiment, the mobile stamp device 110 may put an electronic stamp on the user terminal 120 by transmitting a stamping signal. The detailed description on the stamping is the same as described in the mobile stamp device of FIG. 2.

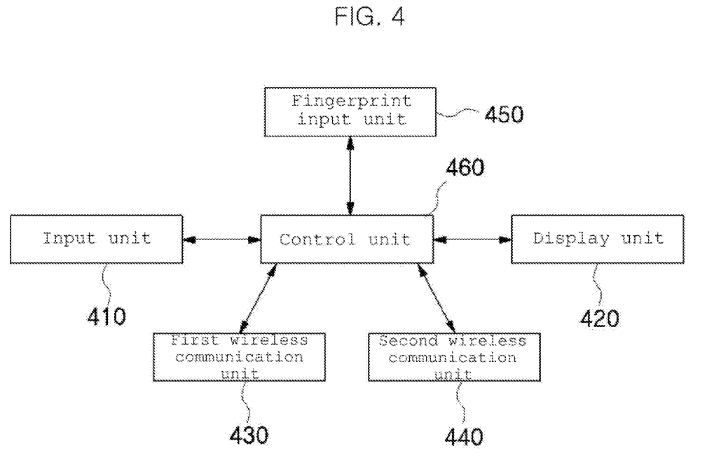

FIG. 4 is a block diagram showing the mobile stamp device shown in FIG. 1.

Referring to FIG. 4, the mobile stamp device 110 includes an input unit 410, a display unit 420, a first wireless communication unit 430, a second wireless communication unit 440, a fingerprint input unit 450 and a control unit 460.

The input unit 410 receives a list or amounts (or information for confirming the amounts) of products or services requested to purchase, and the display unit 420 displays the list or the amounts (or information for confirming the amounts) inputted through the input unit 410 or displays a payment process result received from the electronic stamp payment server 130. In an embodiment, the input unit 410 may correspond to a rotating input means such as a jog shuttle, a key pad 210a, a direction button assembly 210b, a wheel button or a touch pad.

The first wireless communication unit 430 transmits and receives data to and from the user terminal 120. In an embodiment, the first wireless communication unit 430 may include one of an optical communication module, a Bluetooth (BLE) communication module, a near field communication (NFC) module, and an ultrasonic or audible ultrasonic communication module. The first wireless communication unit 430 may transmit a stamping signal to the user terminal 120 under the control of the control unit 460.

In an embodiment, when a stamping event is generated through physical contact of the pattern structure of the mobile stamp device 110 or reception of the stamping signal, the user terminal 120 transmits a stamping confirmation signal to the mobile stamp device 110. If the stamping confirmation signal is received, the first wireless communication unit 430 transmits first payment information of the products or services to the user terminal 120 under the control of the control unit 460. The user terminal 120 transmits the received first payment information to the electronic stamp payment server 130. In an embodiment, the user terminal 120 may transmit at least one or more of user information and information on a payment means, together with the first payment information, to the electronic stamp payment server 130.

In an embodiment, the first payment information may include at least one or more of unique identification information of a corresponding mobile stamp device, a One Time Password (OTP) and a list or amounts (or information for confirming the amounts) of the products or services requested to purchase.

In another embodiment, when a stamping event is generated through physical contact of the pattern structure or reception of the stamping signal, the user terminal 120 transmits second payment information to the mobile stamp device 110. If the second payment information is received, the mobile stamp device 110 may transmit the received second payment information, the unique identification information of a corresponding mobile stamp device, and the list or the amounts (or information for confirming the amounts) of the products or services requested to purchase to the electronic stamp payment server 130.

In an embodiment, the second payment information may include at least one or more of a One Time Password (OTP) and information on a payment means. In an embodiment, the second payment information may further include user information.

In another embodiment, the mobile stamp device 110 may further include an image capturing unit (e.g., a camera module) and may receive the second payment information from the user terminal 120 through the image capturing unit. For example, when a stamping event is generated, the user terminal 120 may output a specific light pattern through the screen. For example, the user terminal 120 may output a specific light pattern by blinking the light or emitting a light of a color (black, white or colored light) different from the previous one.

The user terminal 120 may create a light pattern corresponding to information on a One Time Password (OTP) or a payment means on the basis of the information and output the created light pattern through part or all of the screen. The mobile stamp device 110 may photograph the light pattern outputted on the screen of the user terminal 120 through the image capturing unit and receive the information by analyzing the photographed light pattern.

If the second payment information is received from the user terminal 120 through the light pattern, the mobile stamp device 110 may transmit the received second payment information, the unique identification information of a corresponding mobile stamp device, and the list or the amounts (or information for confirming the amounts) of the products or services requested to purchase to the electronic stamp payment server 130. The second wireless communication unit 440 may transmit and receive data to and from the electronic stamp payment server 130. In an embodiment, the second wireless communication unit 440 may include one of a Bluetooth communication module, a wireless LAN module and a cellular communication module.

The second wireless communication unit 440 may transmit the second payment information received from the user terminal 120 to the electronic stamp payment server 130 under the control of the control unit 460. In an embodiment, the second wireless communication unit 440 may receive a payment process result from the electronic stamp payment server 130.

The fingerprint input unit 450 may receive a fingerprint from the user of a corresponding mobile stamp device. In an embodiment, the mobile stamp device 110 may further include a fingerprint recognition unit (not shown) and directly authenticate the user on the basis of the inputted fingerprint. In another embodiment, the control unit 460 may transmit the inputted fingerprint to the electronic stamp payment server 130 through the second wireless communication unit 440 and request authentication of the corresponding fingerprint.

The control unit 460 controls operation of a corresponding mobile stamp device by controlling the input unit 410, the display unit 420, the first wireless communication unit 430, the second wireless communication unit 440 and the fingerprint input unit 450.

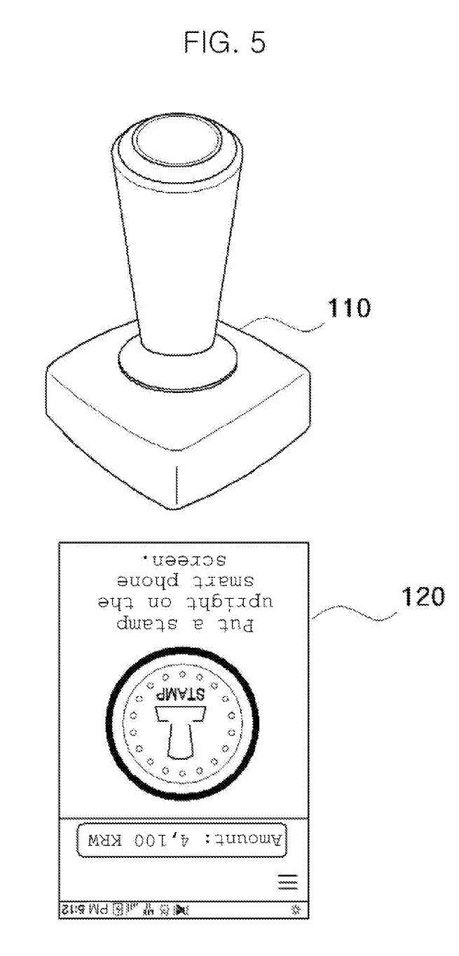

Hereinafter, an electronic stamp payment method using a mobile stamp device will be described with reference to FIGS. 5 to 11.

FIG. 5 is a view showing a screen of stamping on a user terminal using the mobile stamp device shown in FIG. 1.

The user terminal 120 executes an application related to the electronic stamp payment under the user's control. If a payment request event is received under the user's control, the user terminal 120 inverts an electronic stamp input screen upside down and displays the inverted screen on the touch screen. The payment request event may correspond to a user input (e.g., a touch) for confirming to process the payment. The electronic stamp input screen is a screen allowing input of an electronic stamp (i.e., stamping), which may be displayed upside down so that an employee of a product or service provider may easily confirm.

When a stamping event is generated through physical contact of the pattern structure of the mobile stamp device 110 or reception of a stamping signal, the user terminal 120 may display a product or service provider on the screen.

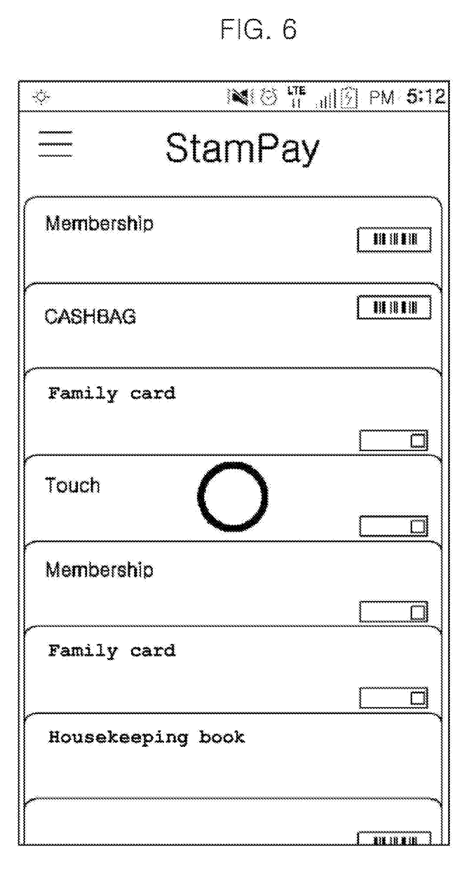

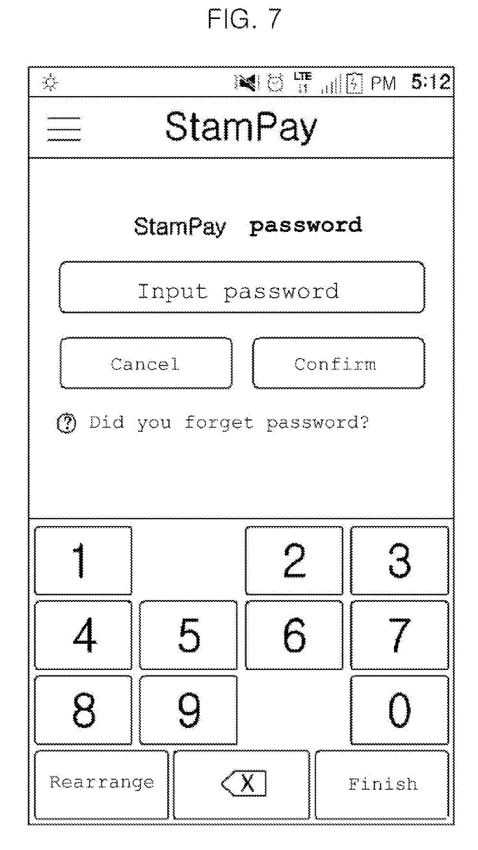

FIG. 6 is a view showing a screen of selecting a payment means in the user terminal shown in FIG. 1, and FIG. 7 is a view showing a screen of inputting a password at the user terminal shown in FIG. 1.

If a stamping event is generated, the user terminal 120 displays payment means on the screen. For example, the payment means may include a credit card, a debit card, a prepaid-type rechargeable card, a fund transfer and a phone bill.

In an embodiment, the user terminal 120 may use a payment means selected by the user, among previously registered means, for payment. In another embodiment, the user terminal 120 may use a payment means previously set to be associated with an application for payment.

If a payment means is selected, the user terminal 120 may display a screen for inputting a password of the corresponding payment means and receive a password under the user's control.

If a payment means is selected and a password is inputted, the user terminal 120 transmits payment information to the electronic stamp payment server 130 in association with the mobile stamp device 110 and requests payment.

In an embodiment, the mobile stamp device 110 transmits first payment information on the products or services to the user terminal 120, and the user terminal 120 may transmit the received first payment information to the electronic stamp payment server 130. In an embodiment, the user terminal 120 may transmit at least one or more of user information and information on the payment means, together with the first payment information, to the electronic stamp payment server 130 and request payment. In an embodiment, the first payment information may include at least one or more of unique identification information of a corresponding mobile stamp device, a One Time Password (OTP) and a list or amounts (or information for confirming the amounts) of products or services requested to purchase.

In another embodiment, the user terminal 120 may transmit second payment information to the mobile stamp device 110, and the mobile stamp device 110 may transmit the received second payment information, the unique identification information of a corresponding mobile stamp device, and the list or the amounts (or information for confirming the amounts) of the products or services requested to purchase to the electronic stamp payment server 130.

In an embodiment, the second payment information may include at least one or more of a One Time Password (OTP) and information on a payment means. In an embodiment, the second payment information may further include user information.

The electronic stamp payment server 130 makes a payment on the basis of the received payment information or the like and transmits a payment process result to the mobile stamp device 110 or the user terminal 120.

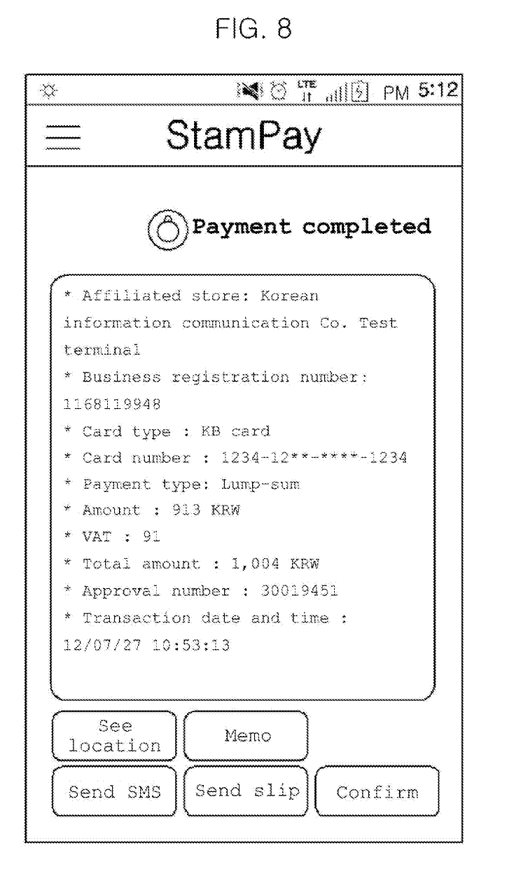

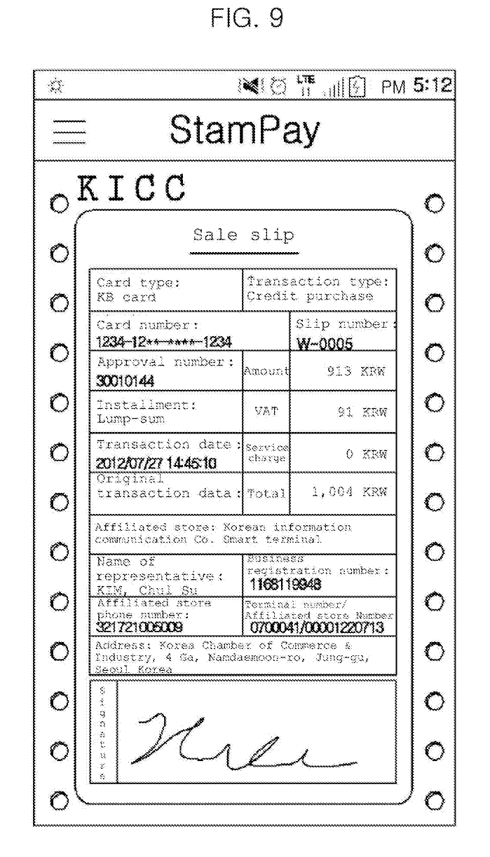

FIG. 8 is a view showing a screen of outputting payment details provided by the electronic stamp payment server shown in FIG. 1 to a user terminal, and FIG. 9 is a view showing a screen of outputting a payment receipt provided by the electronic stamp payment server shown in FIG. 1 to a user terminal.

If the payment is approved, the electronic stamp payment server 130 may provide the user terminal 120 with payment details. When a payment receipt issuance request is received from the user terminal 120, the electronic stamp payment server 130 may provide the user terminal 120 with a payment receipt related to the corresponding payment.

In an embodiment, when a payment cancellation request is received from the mobile stamp device 110 or the user terminal 120, the electronic stamp payment server 130 may cancel the payment and provide the user terminal 120 with details of the payment cancellation. When a payment cancellation receipt issuance request is received from the user terminal 120, the electronic stamp payment server 130 may provide the user terminal 120 with a payment cancellation receipt related to the corresponding payment.

For example, the user terminal 120 may inputted details of a payment to be cancelled under the user's control or receive details of a payment to be cancelled from the mobile stamp device 110. If a stamping event is generated after inputting or receiving the details of a payment to be cancelled, the user terminal 120 may transmit a payment cancellation request to the electronic stamp payment server 130.

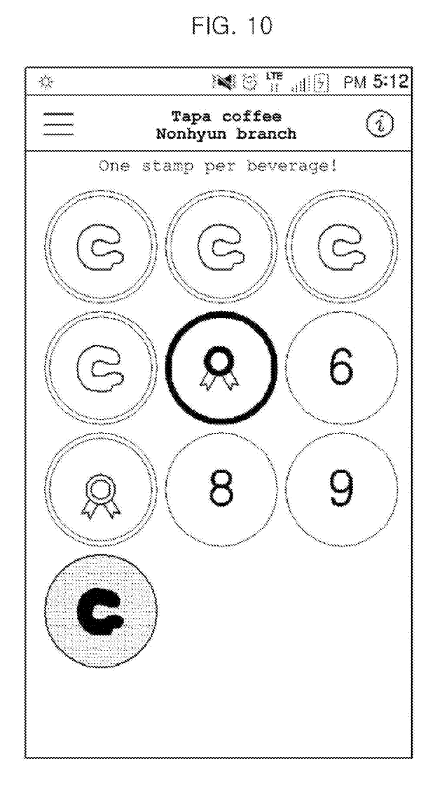

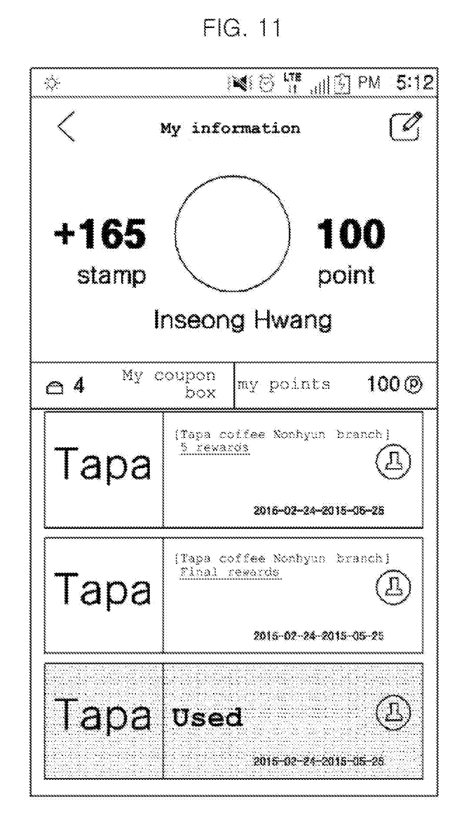

FIG. 10 is a view showing a screen of an electronic stamp accumulation result provided by the user terminal shown in FIG. 1, and FIG. 11 is a view showing a screen of a point accumulation result provided by the user terminal shown in FIG. 1.

In an embodiment, if the payment is approved, the electronic stamp payment server 130 may update the number of mobile stamps for the user of the user terminal 120 by adding mobile stamps related to corresponding payment details. The electronic stamp payment server 130 may provide the user terminal 120 with details of collecting the mobile stamps of the corresponding user.

In another embodiment, if the payment is approved, the electronic stamp payment server 130 may accumulate points related to corresponding payment details and update the points for the user of the user terminal 120. The electronic stamp payment server 130 may provide the user terminal 120 with details of point accumulation of the corresponding user.

In another embodiment, if the payment is approved, the electronic stamp payment server 130 may transmit a coupon related to the corresponding payment details to the user terminal 120.

If cancellation of the payment is approved, the electronic stamp payment server 130 may withdraw or deduct the coupon or the points issued or accumulated for the cancelled payment. In another embodiment, the electronic stamp payment server 130 may remove mobile stamps for the cancelled payment.

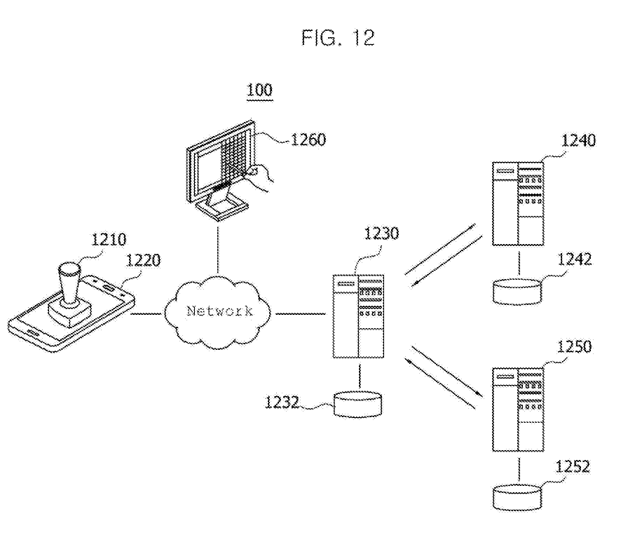

FIG. 12 is a view showing an electronic stamp payment system using a mobile stamp device according to another embodiment of the present invention.

Referring to FIG. 12, an electronic stamp payment system 1200 includes a mobile stamp device 1210, a user terminal 1220, an electronic stamp payment server 1230, a first database 1232, a payment server 1240, a second database 1242, a stamp authentication server 1250, a third database 1252 and an order management device 1260.

Hereinafter, those parts different from the electronic stamp payment system of FIG. 1 will be mainly described for the convenience of explanation.

The order management device 1260 receives a product or service providing list or amounts of each location providing the product or service and transmits the list or the amounts to the electronic stamp payment server. For example, the location providing the product or service corresponds to a table number in a store, and the order management device 1260 may correspond to a Point-Of-Sale (POS) device in the store.

If a product or service providing list or amounts of a location providing a specific product or service is inputted, the order management device 1260 transmits the corresponding list or amounts to the electronic stamp payment server 1230. The electronic stamp payment server 1230 stores and manages the product or service providing list or the amounts of each location.

When a payment is proceeded for the product or service, the mobile stamp device 1210 receives identification information of the location providing the product or service requested to purchase (e.g., a table number of the store). In an embodiment, the mobile stamp device 1210 may receive the identification information of the location providing the product or service requested to purchase under the user's control.

The mobile stamp device 1210 is as described in FIGS. 2 to 4. The input unit receives identification information of the location providing the product or service requested to purchase, and the display unit displays the inputted identification information or a payment process result. The second wireless communication unit may transmit and receive data to and from the electronic stamp payment server 1230, and the first wireless communication unit may transmit and receive data to and from the user terminal 1220. For example, the second wireless communication unit may transmit the inputted identification information to the electronic stamp payment server 1230 and receives a product or service providing list or amounts thereof corresponding to the identification information from the electronic stamp payment server 1230. The first wireless communication unit may transmit unique identification information of the mobile stamp device and a product or service providing list or amounts thereof corresponding to the inputted identification information to the user terminal 1220.

For example, a mobile stamp device 1210 provided with a key pad, a direction button assembly, a wheel button or a touch pad may receive identification information of the location providing the product or service through a corresponding key pad, direction button assembly, wheel button or touch pad. A mobile stamp device 1210 provided with a rotating input means such as a jog shuttle may receive identification information of the location providing the product or service through a rotating operation of the rotating input means. The mobile stamp device 1210 outputs the inputted identification information through the display unit.

For example, the mobile stamp device 1210 may output a table number changing according to a rotating operation through the display unit.

In an embodiment, when identification information of the location providing the product or service is inputted, the mobile stamp device 1210 transmits the inputted identification information to the electronic stamp payment server 1230 and receives a product or service providing list or amounts thereof corresponding to the identification information from the electronic stamp payment server 1230.

If a stamping event is generated as the touch screen is physically touched by the mobile stamp device 1210 or a stamping signal is received from the mobile stamp device 1210, the user terminal 1220 receives a list providing the products or services requested to purchase or amounts thereof from the mobile stamp device 1210 and displays the received list or amounts on the screen.

In another embodiment, if the identification information of the location providing the product or service is inputted into the mobile stamp device 1210 and a stamping event is generated, the mobile stamp device 1210 may transmit the inputted identification information and the identification information of the corresponding mobile stamp device 1210 to the user terminal 1220. The user terminal 1220 transmits the identification information of the location providing the product or service and the identification information of the corresponding mobile stamp device 1210 to the electronic stamp payment server 1230 and receives a product or service providing list or amounts thereof corresponding to the identification information of the location providing the product or service from the electronic stamp payment server 1230. The user terminal 1220 displays the received list or amounts on the screen.

In another embodiment, if a product or service providing list or amounts of a location providing a specific product or service is inputted, the order management device 1260 may store the corresponding list or amounts. If identification information of the location providing the product or service is inputted into the mobile stamp device 1210, the mobile stamp device 1210 may transmit the identification information of the location providing the product or service to the order management device 1260 and receive a list or amounts corresponding to the identification information from the order management device 1260. In an embodiment, the mobile stamp device 1210 may receive a list or amounts corresponding to the identification information from the order management device 1260 through a Bluetooth communication module or a wireless LAN module.

If a stamping event is generated thereafter, the user terminal 1220 receives a list providing the products or services or amounts thereof from the mobile stamp device 1210 and displays the received list or amounts on the screen.

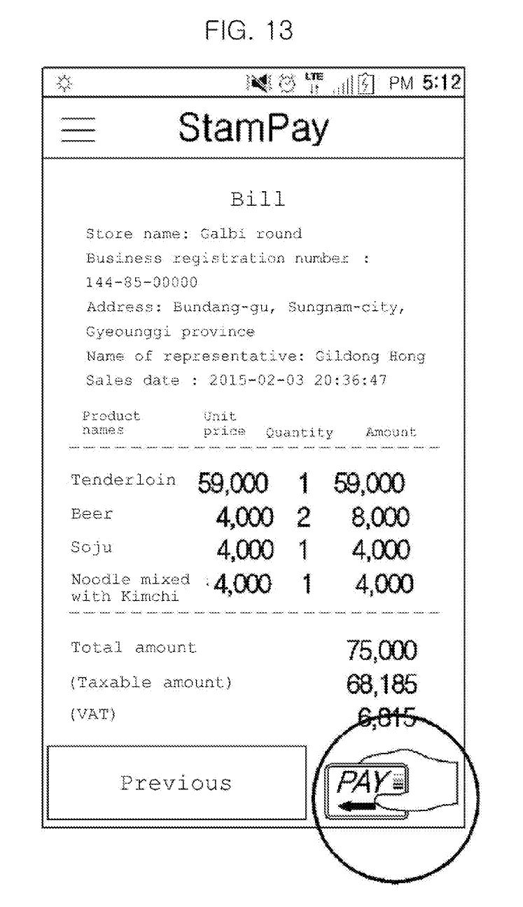

FIG. 13 is a view showing a screen of a product or service providing list or amounts thereof provided by the user terminal shown in FIG. 12.

If a stamping event is generated, the user terminal 1220 may receive a list providing the products or services requested to purchase or amounts thereof from the mobile stamp device 1210 and display the received list or amounts on the screen. The user may proceed the payment on the corresponding list or amounts after confirming the list providing the products or services requested to purchase or the amounts.

If a payment request event corresponding to a user input (e.g., a touch) confirming to make a payment is received, the user terminal 1220 displays payment means on the screen. For example, the payment means may include a credit card, a debit card, a prepaid-type rechargeable card, a fund transfer and a phone bill.

In an embodiment, the user terminal 1220 may use a payment means selected by the user, among previously registered means, for payment. In another embodiment, the user terminal 1220 may use a payment means previously set to be associated with an application for payment.

If a payment means is selected, the user terminal 1220 may display a screen for inputting a password of the corresponding payment means and receive a password under the user's control. If a payment means is selected and a password is inputted, the user terminal 1220 transmits third payment information to the electronic stamp payment server 1230 and requests payment. In an embodiment, the third payment information may include at least one or more of unique identification information of a corresponding mobile stamp device, a One Time Password (OTP) and information on a payment means (e.g., a type of payment means, a payment password of a corresponding payment means and the like).

In an embodiment, the user terminal 1220 may transmit the third payment information and the list providing the products or services requested to purchase or the amounts received from the mobile stamp device 1210 to the electronic stamp payment server 1230 and request payment.

In another embodiment, the user terminal 1220 may transmit the third payment information and the identification information of the location providing the product or service to the electronic stamp payment server 1230 and request payment.

The electronic stamp payment server 1230 receives the third payment information, makes a payment for the corresponding product or service and transmits a payment process result to the mobile stamp device 1210 or the user terminal 1220.

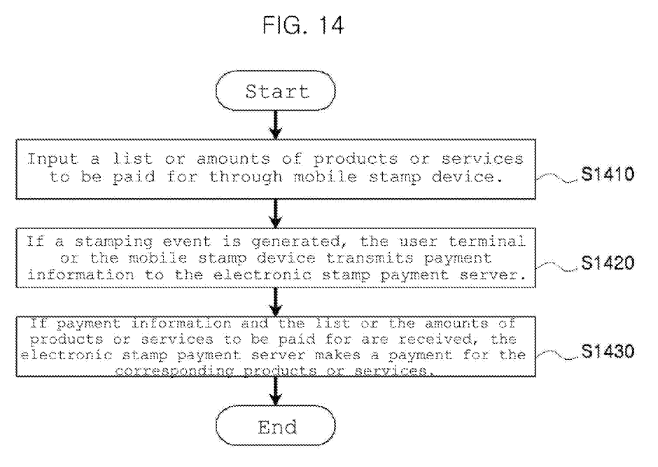

FIG. 14 is a flowchart illustrating a payment process performed by the electronic stamp payment system shown in FIG. 1.

Referring to FIG. 14, the mobile stamp device 110 receives a list or amounts (or information for confirming the amounts) (step S1410) of products or services to be paid for. The mobile stamp device 110 may display the inputted list or amounts (or information for confirming the amounts).

When a stamping event is generated through physical contact of the pattern structure of the mobile stamp device 110 or reception of a stamping signal, the user terminal 120 transmits payment information to the electronic stamp payment server 130 in association with the mobile stamp device 110 (step S1420).

In an embodiment, when a stamping event is generated, the mobile stamp device 110 transmits first payment information on the products or services to the user terminal 120. The user terminal 120 transmits the received first payment information to the electronic stamp payment server 130. In an embodiment, the user terminal 120 may transmit at least one or more of user information and information on a payment means, together with the first payment information, to the electronic stamp payment server 130.

In another embodiment, when a stamping event is generated, the user terminal 120 transmits second payment information to the mobile stamp device 110. If the second payment information is received, the mobile stamp device 110 may transmit the received second payment information, unique identification information of a corresponding mobile stamp device, and a list or amounts (or information for confirming the amounts) of the products or services requested to purchase to the electronic stamp payment server 130.

If the payment information and the list or the amounts (or information for confirming the amounts) of the products or services to be paid for are received, the electronic stamp payment server 130 makes a payment for the corresponding products or services (step S1430). The electronic stamp payment server 130 transmits a payment process result to the mobile stamp device 110 or the user terminal 120. The electronic stamp payment server 130 may issue or accumulate an electronic stamp, a coupon or points related to payment details.

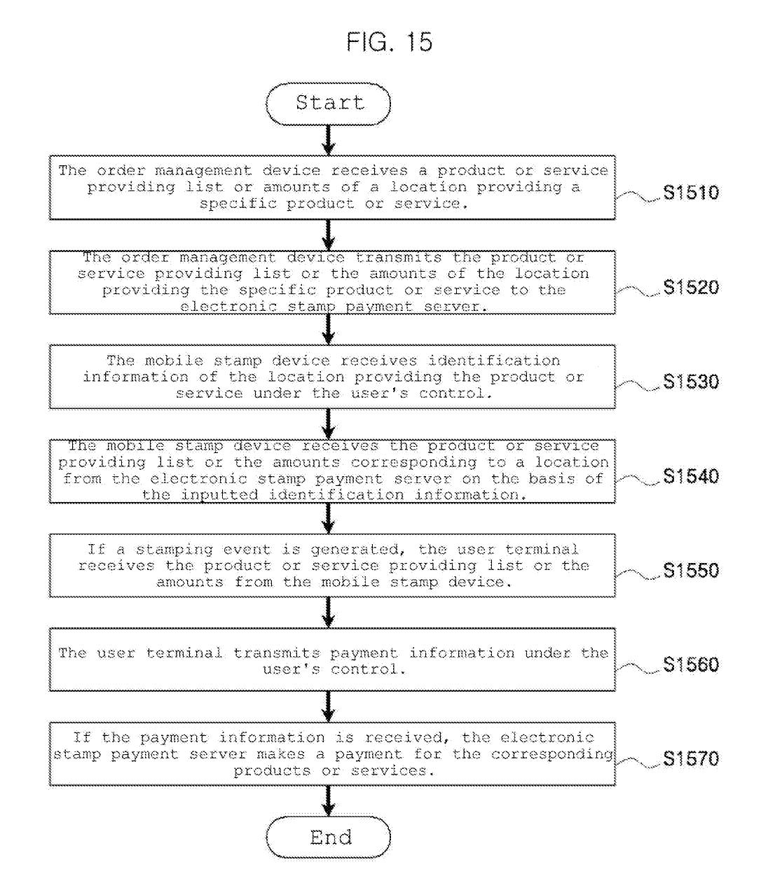

FIG. 15 is a flowchart illustrating a payment process performed by the electronic stamp payment system shown in FIG. 12.

Referring to FIG. 15, the order management device 1260 receives a product or service providing list or amounts of a location providing a specific product or service (step S1510) and transmits the inputted product or service providing list or amounts of the location providing the specific product or service to the electronic stamp payment server 1230 (step S1520).

When a payment is proceeded for the list providing the products or services requested to purchase or the amounts, the mobile stamp device 1210 receives identification information of the location providing the product or service under the user's control (step S1530).

If the identification information of the location providing the product or service is received, the mobile stamp device 1210 receives a product or service providing list or amounts thereof corresponding to the location from the electronic stamp payment server on the basis of the inputted identification information.

When a stamping event is generated through physical contact of the pattern structure of the mobile stamp device 1210 or reception of a stamping signal, the user terminal 1220 receives a product or service providing list or amounts thereof provided from the corresponding location from the mobile stamp device 1210 (step S1550). The user terminal 1220 displays the received product or service providing list or amounts thereof on the screen so that the user may confirm the list or the amounts.

After displaying the product or service providing list or the amounts on the screen, the user terminal 1220 transmits third payment information to the electronic stamp payment server 1230 (step S1560) under the user's control. In an embodiment, the third payment information may include at least one or more of unique identification information of a corresponding mobile stamp device, a One Time Password (OTP) and information on a payment means (e.g., a type of payment means, a payment password of a corresponding payment means and the like).

In an embodiment, the user terminal 1220 may transmit the third payment information and the list providing the products or services requested to purchase or the amounts received from the mobile stamp device 1210 to the electronic stamp payment server 1230 and request payment.

In another embodiment, the user terminal 1220 may transmit the third payment information and the identification information of the location providing the product or service to the electronic stamp payment server 1230 and request payment.

If the payment information is received, the electronic stamp payment server 1230 makes a payment for the corresponding products or services (step S1570). The electronic stamp payment server 1230 transmits a payment process result to the mobile stamp device 1210 or the user terminal 1220. The electronic stamp payment server 1230 may issue or accumulate an electronic stamp, a coupon or points related to payment details.

Although examples of applying a mobile stamp device to a payment system have been described above, the mobile stamp device may be applied to an electronic stamp payment system for confirming a person who pays for electronic documents.

Although it has been described with reference to the preferred embodiments of the present invention, it is to be appreciated that those skilled in the art may diversely change and modify the present invention without departing from the scope and spirit of the present invention.

The present invention relates to an electronic stamp payment technique, and more specifically, to a mobile stamp device which can conveniently request a purchase in an offline space in association with a smart phone.

1. A mobile stamp device for making a payment for a product or a service in association with a user terminal, the device comprising:
an input unit for receiving a list or amounts (or information for confirming the amounts) of products or services requested to purchase;
a display unit for displaying the list or the amounts (or information confirming the amounts) inputted through the input unit or displaying a payment process result; and
a control unit for controlling operation of a corresponding mobile stamp device.

2. The device according to claim 1, wherein the input unit includes at least one of a key pad, a direction button assembly, a wheel button and a touch pad.

3. The device according to claim 1, further comprising a stamp pattern structure that can be recognized by a touch screen of the user terminal.

4. The device according to claim 3, wherein when the stamp pattern structure is touched to the touch screen, the user terminal receives a corresponding pattern and displays a product or service provider corresponding to the pattern on a screen.

5. The device according to claim 3, wherein the stamp pattern structure is formed in a unique pattern for identifying a corresponding mobile stamp device.

6. The device according to claim 1, further comprising a first wireless communication unit capable of transmitting and receiving data to and from the user terminal.

7. The device according to claim 6, wherein the first wireless communication unit includes at least one of an optical communication module, a Bluetooth (BLE) communication module, a near field communication (NFC) module, and an ultrasonic or audible ultrasonic communication module.

8. The device according to claim 6, wherein the control unit puts a stamp on the user terminal by transmitting a stamping signal to the user terminal through the first wireless communication unit.

9. The device according to claim 8, wherein the control unit transmits payment information on the products or services to the stamped user terminal through the first wireless communication unit.

10. The device according to claim 9, wherein the payment information includes at least one or more of unique identification information of a corresponding mobile stamp device, a One Time Password (OTP) and a list or amounts (or information for confirming the amounts) of products or services requested to purchase.

11. The device according to claim 8, wherein the control unit receives the payment information on the products or services from the stamped user terminal through the first wireless communication unit.

12. The device according to claim 11, wherein the payment information includes at least one or more of a One Time Password (OTP) and information on a payment means.

13. The device according to claim 1, further comprising a second wireless communication unit capable of transmitting and receiving data to and from an electronic stamp payment server.

14. The device according to claim 13, wherein the second wireless communication unit includes at least one of a Bluetooth communication module, a wireless LAN module and a cellular communication module.

15. The device according to claim 13, wherein the control unit receives a payment process result from the electronic stamp payment server through the second wireless communication unit.

16. The device according to claim 15, wherein the control unit transmits the payment information received from the user terminal to the electronic stamp payment server through the second wireless communication unit.

17. The device according to claim 1, further comprising a fingerprint input unit for authenticating a user of a corresponding mobile stamp device.

18. The device according to claim 1, further comprising an image capturing unit, wherein the image capturing unit photographs a light pattern outputted from the user terminal and receives information corresponding to the light pattern.

19. A mobile stamp device for making a payment for a product or a service in association with a user terminal, the device comprising:
an input unit for receiving identification information of a location providing the product or service; and
a control unit for controlling operation of a corresponding mobile stamp device.

20. The device according to claim 19, further comprising a display unit for displaying the identification information inputted through the input unit or displaying a payment process result.

21. The device according to claim 19, wherein the input unit includes at least one of a joggle shuttle, a key pad, a direction button assembly, a wheel button and a touch pad.

22. The device according to claim 19, wherein the control unit transmits the inputted identification information to an electronic stamp payment server and receives a product or service providing list or amounts thereof corresponding to the identification information from the electronic stamp payment server.

23. The device according to claim 19, wherein the control unit transmits the inputted identification information to an order management device and receives a product or service providing list or amounts thereof corresponding to the identification information from the order management device.

24. The device according to claim 19, wherein the control unit puts a stamp on the user terminal by transmitting a stamping signal to the user terminal.

25. The device according to claim 23, wherein the control unit transmits unique identification information of a corresponding mobile stamp device and a product or service providing list or amounts thereof corresponding to the inputted identification information to the stamped user terminal.

26. The device according to claim 19, further comprising a fingerprint input unit for authenticating a user of a corresponding mobile stamp device.
